(19) United States
(12) Patent Application Publication
(10) Pub. No.: US 2011/0177993 A1
(43) Pub. Date: Jul. 21, 2011

(54) Process of Preparing a Particle

(76) Inventors: Paul R. Mort, III, Cincinnati, OH (US); Hiram Alejandro Rubalcava Taylor, Mason, OH (US); Francisco Pallares Galvan, Estado de Mexico (MX); Marco Antonio Escobar Velazquez, Mexico City (MX); Hossam Hassan Tantawy, Morpeth (GB); Vincenzo Guida, Rome (IT); Johannes Georg Winter, Unterhaching (DE); David William York, Newcastle upon Tyne (GB); Nigel Patrick Somerville Roberts, Newcastle upon Tyne (GB); Kermit Wayne Kinne, Newport KY, KY (US)

(21) Appl. No.: 13/010,043

(22) Filed: Jan. 20, 2011

Related U.S. Application Data
(60) Provisional application No. 61/296,992, filed on Jan. 21, 2010.

(51) Int. Cl. C11D 17/00

(52) U.S. Cl. 510/466; 510/108; 510/511

(57) ABSTRACT

A process for preparing a particle, the particle having: (i) cleaning active; (ii) structurant having a glass transition temperature; and (iii) optionally, plasticizer; wherein the process includes the step of: (a) contacting the plasticizer, the structurant, and the cleaning active to form a mixture, and forming a particle from the mixture; (b) optionally, removing at least part of the plasticizer from the mixture and/or particle of step (a); wherein the structurant undergoes a glass transformation during step (a) to create an amorphous structure which stabilizes the cleaning active.

### CROSS REFERENCE TO RELATED APPLICATION(S)

This application claims the benefit of U.S. Provisional Application No. 61/296,992, filed Jan. 21, 2010.

### FIELD OF INVENTION

A process for preparing a particle comprising a cleaning active.

### BACKGROUND OF THE INVENTION

There is a need for more efficient cleaning formulations comprising cleaning actives that are traditionally difficult to formulate, more specifically cleaning actives that are relatively sticky and/or hygroscopic in nature. Said formulation efficiencies include but are not limited to superior cold-water cleaning, compact dosing and increased use of renewable raw materials. Advances in detergent formulations have been limited by constraints in processing and stabilization of cleaning actives such as ethoxylated alcohol-derived surfactants, chelants, active polymers, bleaching actives and enzymes. Liquid detergent formulations may be limited by the stability of active ingredients such as bleach and enzymes. In addition to stability limitations of actives, granular detergent formulations may be further constrained by the handling profile of particulates, particularly particulates comprising sticky or hygroscopic cleaning actives such as surfactant, chelant and/or polymer materials.

The present invention overcomes these limitations and constraints and enables, via a specific structuring mechanism, particulate processing of cleaning actives and stabilization thereof. The particles are suitable for use across a range of finished product forms comprising the cleaning actives, said use enabling formulation efficiencies.

### SUMMARY OF THE INVENTION

A process of preparing a particle, the particle comprising: (i) cleaning active; (ii) structurant having a glass transition temperature; and (iii) optionally, plasticizer; wherein the process comprises the step of: (a) contacting the plasticizer, the structurant, and the cleaning active to form a mixture, and forming a particle from the mixture; (b) optionally, removing at least part of the plasticizer from the mixture and/or particle of step (a); wherein the structurant undergoes a glass transformation during step (a) to create an amorphous structure which stabilizes the cleaning active.

### DETAILED DESCRIPTION OF THE INVENTION

The present invention requires a structurant having a glass transition temperature, a plasticizer and a cleaning active. The present invention enables formulation efficiencies via a structuring mechanism, enabling particulate processing of cleaning active materials and stabilization thereof across a range of finished product forms.

Preferably, the in-situ glass transformation of the structurant with the plasticizer, in intimate contact with the cleaning active, provides a way to stabilize the physical and chemical properties of the cleaning active within the resultant particle. In one preferred aspect, the water may be the plasticizer, and may remain in the structured particle without the requirement of a subsequent drying process. In contrast, conventional processes may need to remove the excess water coming from aqueous raw materials; in the process, the water may be absorbed by the structurant.

Preferably, the glass transformation is an endothermic glass-transition structuring reaction, and is more preferably combined with the reduction or elimination of a drying step. This means that particles comprising a cleaning active, especially a thermally-sensitive cleaning active, can be processed without exposure to excessive heat.

### DEFINITIONS

As used herein, the term “cleaning composition” includes, unless otherwise indicated, liquid, granular or powder-form all-purpose or “heavy-duty” washing agents, especially cleaning detergents; hand dishwashing agents or light duty dishwashing agents, especially those of the high-foaming type; machine dishwashing agents; mouthwashes, denture cleaners, car or carpet shampoos, bathroom cleaners; hair shampoos and hair-rinses; shower gels and foam baths and metal cleaners; as well as cleaning auxiliaries such as bleach additives or pre-treat types. In one preferred aspect, the cleaning composition is a laundry detergent composition, more preferably a solid laundry detergent composition, most preferably a free-flowing particulate laundry detergent composition. In one aspect, the cleaning composition is a dish detergent composition, more preferably a solid dish detergent composition, most preferably a free-flowing particulate dish detergent composition. In one aspect, the cleaning composition comprises a particulate dispersed in a liquid detergent composition, more preferably a liquid laundry detergent composition.

As used herein, the articles a and an when used in a claim, are understood to mean one or more of what is claimed or described.

As used herein, the term “active” or “cleaning active” means a functional cleaning chemistry. Preferably, the cleaning active is a surfactant, a chelant, a bleach, an enzyme and/or a polymer.

As used herein, the term “structurant” means a material that is capable of imparting physical or chemical stability to a cleaning active, preferably by the formation of a network structure that is intermixed with the active on a molecular and/or colloidal scale.

As used herein, the term “plasticizer” means a material that is capable modifying or triggering the glass transition behavior of a structurant. Preferably, the plasticizer is capable of reducing the glass transition temperature of the plasticized structurant.

As used herein, the term “glass transition” means the transition of a structurant material into a molecular or colloidal network structure, preferably an amorphous structure.

As used herein, the term “glass transition temperature” means the temperature above which the structurant can form a network structure. A plasticizer may have the effect of lowering the glass transition temperature of a structurant material.

As used herein, the term “agglomerate” means a particle comprising a random composite of ingredients, optionally including an active.

As used herein, the term “layer” means a partial or complete coating of a layering material built up on a particle's surface or on a coating covering at least a portion of said surface. Further, the term “structured layer” means a layer comprising an active, a structurant and optionally a plasticizer.

As used herein, the term “seed” means any particle that can be coated or partially-coated by a layer. Thus, a “seed” may consist of an initial seed particle or a seed with any number of previous layers.

As used herein, the term “structured particle” preferably means a structured agglomerate, layered particle with a structured seed, layered particle with a structured layer, or any combination thereof.

It is understood that the test methods that are disclosed in the Test Methods Section of the present application must be used to determine the respective values of the parameters of Applicants' inventions as such inventions are described and claimed herein.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited are, in relevant part, incorporated herein by reference; the citation of any document is not to be construed as an admission that it is prior art with respect to the present invention.

### Cleaning Active, Plasticizer and Pre-Mixture

In one preferred aspect, the cleaning active and plasticizer may be in the form of a pre-mixture. Preferably, at least part of, preferably substantially all of, more preferably all of, the cleaning active and plasticizer are pre-mixed prior to contact with at least part of, preferably substantially all of, more preferably all of, the structurant.

The pre-mixture may be an aqueous surfactant paste, preferably a high active surfactant paste with a surfactant activity greater than about 70%., preferably greater than 75 wt %, or greater than 80 wt %, or greater than 85 wt %, or greater than 90 wt %, or greater than 95 wt %, or even 99 wt % or greater. In one aspect, the active surfactant comprises an alkylalkoxysulfate, preferably sodium alkylethoxysulfate, (AES), wherein the degree of alkoxylation, preferable ethyoxylation, is preferably in the range of about 0.1 to 10, or preferably from 0.5 to 5, or about 0.5 to 3 moles of alkoxylate, preferably ethoxylate, per mole of surfactant.

The pre-mixture may be an aqueous chelant solution, preferably with a chelant activity greater than about 35%. Suitable chelants include, but are not limited to, tetrasodium carboxylatomethyl-glutamate (Dissolvine® or GLDA), trisodium methylglycinediacetate (Trilon® M or MGDA), diethylene triamine pentaacetic acid (DTPA) or ethylenediamine tetraacetic acid (EDTA).

The active-plasticizer mixture may be an aqueous enzyme broth, preferably with a protein concentration greater than about 4%. Suitable enzymes include, but are not limited to, protease, amylase, cellulase, xyloglucanase, mannanase, pectate lyase and/or lipase.

The pre-mixture may be an aqueous polymer solution, preferably with a polymer activity greater than about 35%. Suitable polymers include, but are not limited to, polymeric carboxylates, such as polyacrylates, poly acrylic-maleic co-polymers, and sulfonated modifications thereof. The polymer may be a cellulosic based polymer, a polyester, a polyterephthalate, a polyethylene glycol, a polyethyleneimine, any modified variant thereof, such as polyethylene glycol having grafted vinyl and/or alcohol moieties, and any combination thereof.

Preferably, the weight ratio of cleaning active to plasticizer present in the pre-mixture is in the range of from 1:1 to 999:1, or preferably from 2:1, or from 3:1, or from 4:1, and even from 5:1, and preferably to 99:1, or to 75:1, or to 50:1, or even to 40:1.

### Structurant

In one preferred aspect, the structurant can form an amorphous structure in a glassy or rubbery state. Suitable structurants capable of forming an amorphous glass and are preferably selected from borates, phosphates, silicates and/or polymers. Preferred structurants are in the form of a fine powder material. Structurant powders may be milled or micronized to reduce their initial particle size, providing more surface area for intimate mixing in the contacting process.

In one aspect, the structurant comprises an alkaline metal silicate, (M₂O).x(SiO₂), where M is an alkaline metal, preferably selected from sodium, potassium or lithium. In one aspect, the structurant comprises an alkaline earth metal silicate (MO).x(SiO₂), where M is an alkaline earth metal, preferably selected from calcium or magnesium. In the two previous aspects, the ratio x is preferably in the range of 1.6 to 3.2. In one aspect, the structurant comprises a blend of alkaline and/or alkaline earth metal silicates. In one aspect, said silicate may be in the form of a weakly-crystalline material, preferably with a median primary crystallite size less than about 500 nm, less than 200 nm, or even less than about 100 nm.

The structurant raw material may have a crystalline, weak crystalline or amorphous phase structure.

In one aspect, the structurant is polyvinyl alcohol (PVA) resin, or hydrolyzed variation thereof.

In one aspect, a cross-linking agent may be added to reinforce the amorphous network formed by the structurant. In the case of a PVA structurant, a preferred cross-linking agent is boric acid.

The structurant preferably comprises: polyvinyl pyrrolidone (PVP) and/or derivatives thereof; cellulose ethers and/or derivatives thereof; polyacrylamide and/or derivatives thereof; polyethylene oxide and/or derivatives thereof; polyethylene imine and/or derivatives thereof; and any combination thereof. The structurant may comprise co-polymers of the polymers described hereinabove with one another, or with other monomers or oligomers.

A suitable structurant comprises polymer, preferably selected from polyvinyl alcohol, polyvinyl pyrrolidone, cellulosic polymer, starch, sugar, and any combination thereof.

Preferably, the structurant is water-soluble. By water-soluble it is typically meant that a material has a % water-solubility or water-dispersibility of 5 wt % or less insoluble material, preferably 3 wt % or less insoluble material, more preferably 1 wt % or less insoluble material, or even 0.1 wt % or less insoluble material, when determined by the water dispersibility and solubility test method, which is described in more detail later.

Highly preferably, the structurant is a silicate. Preferred silicates are selected from sodium silicate, potassium silicate, lithium silicate, calcium silicate, magnesium silicate, and any combination thereof. A highly preferred silicate is sodium silicate.

### Particle

The particle comprises cleaning active, structurant and optionally plasticizer. The particle may comprise from 0.1 wt % to 10 wt % water, preferably from 1 wt % to 5 wt % water.

The particle is preferably a structured particulate. In one aspect, said particle may be formulated in a granular or powder cleaning product. In one aspect, said particle may be formulated as a particulate suspended in a liquid matrix. In one aspect, said particle may be formulated in a unit dose detergent, either in a granular or powder matrix, as a particulate suspended in a liquid matrix, or as a particulate embedded in a soluble film.

Product advantages include formulation of cleaning actives in a particle form with chemical and physical stability suitable for use in fully formulated detergent products. Especially preferred are actives which may be difficult to process and/or stabilize physically and/or chemically using conventional detergent particle-formation methods such as agglomeration or spray-drying. Preferred actives include but are not limited to hygroscopic actives (e.g., chelants), actives whose raw material precursor is in the form of a liquid solution, paste or suspension (e.g., surfactant pastes, surfactant solutions, polymer solutions, chelant solutions, enzyme broths), and actives whose dried form has a soft solid or sticky paste consistency (e.g., ethoxylated surfactants).

The cleaning active may be hygroscopic.

The cleaning active is preferably selected from detersive surfactant, chelant, water-soluble polymer, enzyme, bleaching active, perfume, hueing agent, silicone and any combination thereof.

The process advantages include simplified processing of detergent particles, especially those comprising preferred cleaning actives outlined above, where conventional particle processing methods are difficult or practically unfeasible in the context of a efficient formulation needs. Simplified processes may include, but are not limited to agglomeration, spray-drying, gelation, extrusion, extraction, and prilling.

Preferably, the particle when initially equilibrated to ambient conditions of from 30% relative humidity and temperature of 22° C., and then exposed in an open container for 24 hours to conditions of (i) environmental relative humidity of 74%, and (ii) a temperature of 27° C., retains a flowability of at least 4, preferably at least 5, or at least 6, or at least 7, or at least 8, or at least 9, or even at least 10. Further, the particle may be hygroscopic, wherein it has a weight gain of greater than about 3 mass %, 6 mass % or even 10 mass % during the exposure period, and it retains a flowability of at least 4. The flowability test method is described in more detail later.

The particle preferably comprises at least 30 wt %, or even at least 35 wt %, or at least 40 wt %, or at least 45 wt %, or at least 50 wt %, or at least 55 wt %, or even at least 60 wt %, or even 65 wt % cleaning active. Preferably the particle comprises to 95 wt %, or to 90 wt %, or to 80 wt %, or even to 70 wt % cleaning active.

### Mechanism of Structuring

In one aspect, the cleaning active may be combined with a plasticizer, said plasticizer may have additional active profiles itself or may be a non-active plasticizer, Preferably, the plasticizer is intimately mixed with the active material to form a pre-mixture, for example a preferred pre-mixture is aqueous surfactant paste, wherein the surfactant is the cleaning active and water is the plasticizer.

Preferably, a contacting process step brings the structurant, plasticizer and cleaning active into intimate contact such that the plasticizer interacts with the structurant, causing the structurant to undergo a glass transition, preferably forming a microstructure network in intimate contact with the active, said microstructure network stabilizing the active.

While not being bound by theory, it is postulated that the plasticized structurant can form an amorphous (i.e., glassy and/or rubbery) molecular structure.

In one aspect, the process of preparing a particle, the particle comprising: (i) cleaning active; (ii) structurant having a glass transition temperature; and (iii) optionally, plasticizer; the process comprises the step of: (a) contacting the plasticizer, the structurant, and the cleaning active to form a mixture, and forming a particle from the mixture; and (b) optionally, removing at least part of the plasticizer from the mixture and/or particle of step (a); wherein the structurant undergoes a glass transformation during step (a) to create an amorphous structure which stabilizes the cleaning active.

In one aspect, preferably the unplasticized structurant has a glass transition temperature above the temperature of said process step (a). More preferably, during said process step (a), the structurant is plasticized. Even more preferably, the temperature of said process step (a) is controlled such that the glass transition temperature of the plasticized structurant is below the temperature of said process step (a). In one aspect, the temperature of said process step (a) is raised such that the temperature of said process step (a) is above the glass transition temperature of the structurant, preferably the plasticized structurant. Preferably, the glass transition temperature of the structurant is initially greater than the said process step (a) temperature, and drops below the said process step (a) temperature when sufficiently contacted by the plasticizer.

While not being bound by theory, it is believed that the reduction of the glass transition temperature below temperature of said process step (a) provides a driving force for the conversion of the structurant material into a rubbery or amorphous state. Evidence of this endothermic transition is observed in the reduction of the process temperature, i.e., heat is drawn out of the process by a glass-transition endotherm.

In one aspect, silicate is a preferred structurant and water is a preferred plasticizer. While not being bound by theory, it is believed that the glass transition of said silicate may provide octahedral coordination sites for water molecules in the microstructure network. Further, it is believed that the molecular binding sites for water in the network microstructure helps to stabilizing the solid physical properties of particles comprising residual water, i.e., as a means to eliminate the need for a drying step in the process. Further, it is believed that the additional molecular binding sites in the network microstructure, stabilizes the material when exposed to conditions of high humidity.

### Process of Making a Particle

The process comprises the steps of (a) contacting the plasticizer, the structurant, and the cleaning active to form a mixture, and forming a particle from the mixture; and (b) optionally, removing at least part of, or at least substantially all of, or even all of, the plasticizer from the mixture and/or particle of step (a). The structurant undergoes a glass transformation during step (a) to create an amorphous structure which stabilizes the cleaning active.

Preferably, the plasticizer comprises water, and preferably step (b) is carried out, and more preferably step (b) is an evaporative drying step, and even more preferably at least part of the plasticizer, preferably substantially all of, or all of, the plasticizer is removed from the mixture and/or particle of step (a).

### A Preferred Process Comprises the Steps:

1. Obtain a suitable structurant, preferably in a fine powder form. Optionally, the structurant may be micronized to form a fine powder by milling, grinding or a comminuting step with any apparatus known in the art for milling, grinding or comminuting of granular or particulate compositions. The structurant may be optionally combined with any other active or inactive detergent powder material.
2. Obtain a suitable binder material. In one aspect, said binder comprises a plasticizer. In one aspect, said binder comprises a cleaning active. In one aspect, said binder comprises a pre-mixture of a cleaning active with a plasticizer.
3. Combine the above materials plus any additional plasticizers, cleaning actives and optional recycle materials in a mixing chamber to make particles such as structured particles. The mixing process involves contacting the structurant, plasticizer and cleaning active to achieve a substantially homogenous dispersion of the active with the plasticized structurant. Said mixing chamber may be any apparatus known in the art for agglomeration, granulation, granular mixing or layering of granular or particulate compositions. Examples of suitable mixer granulators include, but are not limited to, dual-axis counter-rotating paddle mixers, high-shear horizontal-axis mixer granulators, vertical-axis mixer-granulators, and V-blenders with intensifier elements. Such mixers may be batch or continuous in operation. In one aspect, said mixing chamber is a medium to high shear mixer with a primary impeller having a tip speed of 0.5 to 50 meters/second, 1 to 25 meters/second, 1.5 to 10 meters/second, or even 2 to 5 meters/second. In one aspect, said binder addition is done by atomization of the binder using a nozzle, contacting said spray with the powder mixture. In one aspect, said mixing chamber is a ploughshare mixer with a chopper located between the ploughs. In one aspect, said binder is added adjacent to the chopper location. In one aspect, said mixing chamber is a dual-axis counter-rotating paddle mixer, for example as described in US 2007/0196502. In one aspect, said binder is added by top-spray in the central fluidized zone of said counter-rotating dual-axis paddle mixer. In one aspect, said binder is added upward into the converging flow zone between the counter-rotating paddle axes of said counter-rotating dual-axis paddle mixer. In one aspect, said particles may be at least partially dried concurrent with the mixing-granulation process.
4. Optionally, said particles may be at least partially dried in a subsequent drying process. In one aspect, said drying process is a fluidized bed drier.
5. Optionally, classifying the particles of step 4 to obtain particles with an acceptable particle size distribution, where any oversize or undersize materials may optionally be recycled to process step 3 above. Said classification may be done with any apparatus known in the art for particulate classification, separation, screening or elutriation of particulate compositions. In one aspect, any oversize material may reduced in particle size before recycling by milling, grinding or comminuting with any apparatus known in the art for milling, grinding or comminuting of granular or particulate compositions. In one aspect, said product granules may be treated by screening out oversized particles using equipment such as a vibratory screener.
6. Optionally, said particles of step 5 may be used as a seed in a subsequent layering process to make a layered granule wherein structured particle comprises the seed of the layered granule. In one aspect, said layering process is described in US 2007/0196502. In one aspect, said layer may comprise additional detergent ingredients.
7. Optionally, a structured particulate comprising a seed and a structured layer may be prepared according to the process described above with the addition of a suitable seed particulate in step 3. In one aspect, said seed is at least 50 wt % of the structured particles produced in step 3. In one aspect, said seed has a median particle diameter of from about 150 microns to about 1700 microns, from about 200 microns to about 1200 microns, from about 250 microns to about 850 microns or even from about 300 microns to about 600 microns. In one aspect, said seed has a size distribution span of from about 1.0 to about 2.0, from about 1.05 to about 1.7, or even from about 1.1 to about 1.5. In one aspect, said structured particulate comprising a seed and a structured layer may be prepared in accordance with US 2007/0196502, wherein the layering powder of US 2007/0196502 is comprises a suitable structurant and the binder of US 2007/0196502 comprises a suitable plasticizer and cleaning active. In one aspect, said seed may comprise additional detergent ingredients.

### Making the Finished Granular Laundry Detergent Composition

A finished granular laundry detergent product is made by mixing said structured particulate with optional dry admix ingredients and/or optional liquid spray-on ingredients. Finished granular laundry detergent compositions are typically formulated such that, during use in aqueous cleaning operations, the wash water will have a pH of between about 6.5 and about 12, or between about 7.5 and 10.5. Techniques for controlling pH at recommended usage levels include, but are not limited to, the use of buffers, alkalis, acids, etc., and are well known to those skilled in the art.

### Finished Product Comprising Particles

Surfactants—The cleaning compositions may comprise a surfactant or surfactant system wherein the surfactant can be selected from nonionic surfactants, anionic surfactants, cationic surfactants, ampholytic surfactants, zwitterionic surfactants, semi-polar nonionic surfactants and mixtures thereof. When present, surfactant is typically present at a level of from about 0.1% to about 60%, from about 1% to about 50% or even from about 5% to about 40% by weight of the subject composition. In one aspect, the cleaning active of the structured particulate comprises a surfactant. In one aspect, the cleaning active of the structured particulate comprises an ethoxylated sulfate surfactant. In one aspect, said alkane chain of said ethoxylated sufate surfactant has a median carbon chain length of from about 12 to 18, or from about 14 to 16. In one aspect, said ethoxylated sufate surfactant has a median degree of ethoxylation of from about 0.5 to 5, or from about 1 to 3.

Builders—The cleaning compositions may comprise one or more detergent builders or builder systems. When a builder is used, the subject composition will typically comprise at least about 1%, from about 5% to about 60% or even from about 10% to about 40% builder by weight of the subject composition.

Builders include, but are not limited to, the alkali metal, ammonium and alkanolammonium salts of polyphosphates, alkali metal silicates, alkaline earth and alkali metal carbonates, aluminosilicate builders and polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

Chelating Agents—The cleaning compositions herein may contain a chelating agent. Suitable chelating agents include, but are not limited to, copper, iron and/or manganese chelating agents and mixtures thereof. When a chelating agent is used, the subject composition may comprise from about 0.005% to about 25%, from about 1% to about 15%, or even from about 3.0% to about 10% chelating agent by weight of the subject composition. In one aspect, the cleaning active of the structured particulate comprises a chelant. In one aspect, the cleaning active of the structured particulate comprises tetrasodium carboxylatomethyl-glutamate (Dissolvine® or GLDA), trisodium methylglycinediacetate (Trilon® M or MGDA), diethylene triamine pentaacetic acid (DTPA) or ethylenediamine tetraacetic acid (EDTA),

Dye Transfer Inhibiting Agents—The cleaning compositions of the present invention may also include, but are not limited to, one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

Brighteners—The cleaning compositions of the present invention can also contain additional components that may tint articles being cleaned, such as fluorescent brighteners. Suitable fluorescent brightener levels include lower levels of from about 0.01, from about 0.05, from about 0.1 or even from about 0.2 wt % to upper levels of 0.5 or even 0.75 wt %.

Dispersants—The compositions of the present invention can also contain dispersants. Suitable water-soluble organic materials include, but are not limited to, the homo- or co-polymeric acids or their salts, in which the polycarboxylic acid comprises at least two carboxyl radicals separated from each other by not more than two carbon atoms.

Enzymes—The cleaning compositions can comprise one or more enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in a cleaning composition, the aforementioned enzymes may be present at levels from about 0.00001% to about 2%, from about 0.0001% to about 1% or even from about 0.001% to about 0.5% enzyme protein by weight of the composition.

Enzyme Stabilizers—Enzymes for use in detergents can be stabilized by various techniques. The enzymes employed herein can be stabilized by the presence of water-soluble sources of calcium and/or magnesium ions in the finished compositions that provide such ions to the enzymes. In case of aqueous compositions comprising protease, a reversible protease inhibitor, such as a boron compound, can be added to further improve stability.

Bleaching Agents—The cleaning compositions of the present invention may comprise one or more bleaching agents. Suitable bleaching agents other than bleaching catalysts include, but are not limited to, photobleaches, bleach activators, hydrogen peroxide, sources of hydrogen peroxide, pre-formed peracids and mixtures thereof. In general, when a bleaching agent is used, the compositions of the present invention may comprise from about 0.1% to about 50% or even from about 0.1% to about 25% bleaching agent by weight of the subject cleaning composition. Examples of suitable bleaching agents include, but are not limited to
(1) preformed peracids: Suitable preformed peracids include, but are not limited to, compounds selected from the group consisting of percarboxylic acids and salts, percarbonic acids and salts, perimidic acids and salts, peroxymonosulfuric acids and salts, for example, Oxone®, and mixtures thereof. Suitable percarboxylic acids include, but are not limited to, hydrophobic and hydrophilic peracids having the formula R—(C═O)O—O—M wherein R is an alkyl group, optionally branched, having, when the peracid is hydrophobic, from 6 to 14 carbon atoms, or from 8 to 12 carbon atoms and, when the peracid is hydrophilic, less than 6 carbon atoms or even less than 4 carbon atoms; and M is a counterion, for example, sodium, potassium or hydrogen;
(2) sources of hydrogen peroxide, for example, inorganic perhydrate salts, including alkali metal salts such as sodium salts of perborate (usually mono- or tetra-hydrate), percarbonate, persulphate, perphosphate, persilicate salts and mixtures thereof. In one aspect of the invention the inorganic perhydrate salts are selected from the group consisting of sodium salts of perborate, percarbonate and mixtures thereof. When employed, inorganic perhydrate salts are typically present in amounts of from 0.05 to 40 wt %, or 1 to 30 wt % of the overall composition and are typically incorporated into such compositions as a crystalline solid that may be coated. Suitable coatings include, but are not limited to, inorganic salts such as alkali metal silicate, carbonate or borate salts or mixtures thereof, or organic materials such as water-soluble or dispersible polymers, waxes, oils or fatty soaps; and
(3) bleach activators having R—(C═O)—L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is leaving group. Examples of suitable leaving groups are benzoic acid and derivatives thereof—especially benzene sulphonate. Suitable bleach activators include, but are not limited to, dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED) and nonanoyloxybenzene sulphonate (NOBS). Suitable bleach activators are also disclosed in WO 98/17767. While any suitable bleach activator may be employed, in one aspect of the invention the subject cleaning composition may comprise NOBS, TAED or mixtures thereof.

When present, the peracid and/or bleach activator is generally present in the composition in an amount of from about 0.1 to about 60 wt %, from about 0.5 to about 40 wt % or even from about 0.6 to about 10 wt % based on the composition. One or more hydrophobic peracids or precursors thereof may be used in combination with one or more hydrophilic peracid or precursor thereof.

The amounts of hydrogen peroxide source and peracid or bleach activator may be selected such that the molar ratio of available oxygen (from the peroxide source) to peracid is from 1:1 to 35:1, or even 2:1 to 10:1.

Catalytic Metal Complexes—Applicants' cleaning compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, but are not limited to, for example, the manganese-based catalysts disclosed in U.S. Pat. No. 5,576,282.

Cobalt bleach catalysts useful herein are known, and are described, for example, in U.S. Pat. No. 5,597,936; U.S. Pat. No. 5,595,967. Such cobalt catalysts are readily prepared by known procedures, such as taught for example in U.S. Pat. No. 5,597,936, and U.S. Pat. No. 5,595,967.

Compositions herein may also suitably include a transition metal complex of ligands such as bispidones (WO 05/042532 A1) and/or macropolycyclic rigid ligands—abbreviated as “MRLs”. As a practical matter, and not by way of limitation, the compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include, but are not limited to, for example, manganese, iron and chromium. Suitable MRLs include, but are not limited to, 5,12-diethyl-1,5,8,12-tetraazabicyclo[6.6.2]hexadecane.

Suitable transition metal MRLs are readily prepared by known procedures, such as taught for example in WO 00/32601, and U.S. Pat. No. 6,225,464.

The cleaning composition may have a reserve alkalinity of 12 or less.

Typically, the composition has a reserve alkalinity of at least 1.0, or at least 2.0, preferably at least 3.0, or at even least 4.0, and preferably the composition has a reserve alkalinity of to 12, or to 11, or even to 10. The test method used to determine the reserve alkalinity is described in more detail later.

### Method of Using Cleaning Compositions

The compositions are typically used for cleaning and/or treating a situs inter alia a surface or fabric. Such method includes the steps of contacting an embodiment of Applicants'cleaning composition, in neat form or diluted in a wash liquor, with at least a portion of a surface or fabric then optionally rinsing such surface or fabric. The surface or fabric may be subjected to a washing step prior to the aforementioned rinsing step. For purposes of the present invention, washing includes but is not limited to, scrubbing, and mechanical agitation. As will be appreciated by one skilled in the art, the cleaning compositions of the present invention are ideally suited for use in laundry applications. Accordingly, the present invention includes a method for laundering a fabric. The method may comprise the steps of contacting a fabric to be laundered with a said cleaning laundry solution comprising at least one embodiment of Applicants' cleaning composition, cleaning additive or mixture thereof. The fabric may comprise most any fabric capable of being laundered in normal consumer use conditions. The solution preferably has a pH of from about 8 to about 10.5. The compositions may be employed at concentrations of from about 500 ppm to about 15,000 ppm in solution. The water temperatures typically range from about 5° C. to about 90° C. The water to fabric ratio is typically from about 1:1 to about 30:1.

### Test Methods

### Water Dispersibility and Solubility Test Method

1. Weight 3.5 g of the material and dose it into an 8 oz. bottle. 2. Add 150 ml water to the bottle, cap and place in a 70° C. water bath for 3 hours. 3. Remove the bottle from the water-bath and stir with a magnetic stirrer set at 600 rpm for 1 hour. 4. Filter the samples through a pre-weighed sheet of tared filter paper using a filter holder assembly (such as a Model XX1004700 supplied by Millipore Corp., Mass., USA) and a cellulose membrane filter having a pore size of 0.45 micrometers (such as a HAWP04700 filter supplied by Millipore Corp., Mass., USA)). The bottles are rinsed five (5) times with 150 ml of water to ensure the removal of the sample from the bottle, and the rinse water is also poured through the filter. 5. The filter paper with any solid materials collected from the bottle is folded to ensure none of the solid materials is lost and then placed in a tared 150 ml beaker and dried overnight at 100° C. 6. The filter paper is then placed in a desiccators to dry and cool to room temperature (25° C.) until constant weight is obtained, and is then weighed. The weight of the solid material left on the filter paper is determined according to the gross weight of the dried filter containing any residue minus the initial tare weight of the filter. 7. The % water-solubility or water-dispersibility is calculated as follows: 100%-wt % insoluble material, where wt % insoluble material=100×(weight (in grams) of solid material on the filter paper after step 6/weight (in grams) of sample dosed in step 1 (3.5 g)).

### Method for Measuring Flowability

A smooth plastic cylinder of internal diameter 6.35 cm and length 15.9 cm is supported on a suitable base plate such that the assembly stands on the base plate with the axis of the smooth cylinder in a vertical orientation. The cylinder has a 0.65 cm diameter hole perpendicular to its axis, with the centre of the hole being 9.2 cm from the end opposite the base plate.

A metal pin is inserted through the hole and a smooth plastic sleeve of internal diameter 6.35 cm and length 15.25 cm is placed around the inner cylinder such that the sleeve can move freely up and down the cylinder and comes to rest on the metal pin. The space inside the sleeve is then filled (without tapping or excessive vibration) with the particulate such that the particulate heaps above the top of the sleeve, and is then scraped level with the top of the sleeve. A lid is placed on top of the sleeve and a consolidation mass of 5 kg is placed on the lid. The lid mass is not to exceed 0.1 kg. The consolidation stress is the sum of the lid and consolidation mass (in kilogram units, kg), multiplied by gravitational acceleration (9.81 m/ŝ2), divided by the end area of the cake (0.003167 m̂2), then divided by 1000 to give the consolidation stress in kilopascal units (kPa). The pin is then removed and the particulate is allowed to compact for 2 minutes. After 2 minutes the weight is removed, the sleeve is lowered to expose the compressed particulate cake with the lid remaining on top of the compressed particulate.

A metal probe attached to a force gauge capable of recording a maximum applied force is then lowered at 54 cm/min such that it contacts the centre of the lid and breaks the cake. The unconfined yield stress is calculated as the maximum force required to break the cake, measured in Newtons (N) plus the load of the lid [lid mass (kg) times the gravitational constant (9.81 m/ŝ2)], divided by the end area of the cake (0.003167 m̂2), then divided by 1000 to give the unconfined yield stress in kilopascal units (kPa). If the cake collapses under the weight of the lid, then the stress of the lid is recorded as the unconfined yield stress.

The flowability is defined as the consolidation stress divided by the unconfined yield stress. A flowability >=10 is “free flowing”; flowability <10 and >=4 is “easy flowing”; flowability <4 and >=2 is “cohesive”; flowability <2 and >=1 is “very cohesive”; flowability <1 is “non flowing”.

### Reserve Alkalinity

As used herein, the term “reserve alkalinity” is a measure of the buffering capacity of the laundry detergent composition (g/NaOH/100 g detergent composition) determined by titrating a 1% (w/v) solution of detergent composition with hydrochloric acid to pH 7.5 i.e in order to calculate Reserve Alkalinity as defined herein:

Reserve Alkalinity (to pH 7.5) as % alkali in g NaOH/100 g product=T×M×40×Vol 10×Wt×Aliquot

T=titre (ml) to pH 7.5

M=Molarity of HCl=0.2

40=Molecular weight of NaOH

Vol=Total volume (ie. 1000 ml)

W=Weight of product (10 g)

Aliquot=(100 ml)

Obtain a 10 g sample accurately weighed to two decimal places, of the composition. The sample should be obtained using a Pascall sampler in a dust cabinet. Add the 10 g sample to a plastic beaker and add 200 ml of carbon dioxide-free de-ionised water. Agitate using a magnetic stirrer on a stirring plate at 150 rpm until fully dissolved and for at least 15 minutes. Transfer the contents of the beaker to a 1 litre volumetric flask and make up to 1 litre with deionised water. Mix well and take a 100 mls*1 ml aliquot using a 100 mls pipette immediately. Measure and record the pH and temperature of the sample using a pH meter capable of reading to ±0.01 pH units, with stirring, ensuring temperature is 21° C.+/−2° C. Titrate whilst stirring with 0.2M hydrochloric acid until pH measures exactly 7.5. Note the millilitres of hydrochloric acid used. Take the average titre of three identical repeats. Carry out the calculation described above to calculate RA to pH 7.5.

### EXAMPLES

### Example 1

### Process for Making a Structured Detergent Particulate Using a Pre-Blend of a Surfactant Active and Plasticizer

A structured particulate is prepared using a mixer-agglomerator process to contact an aqueous surfactant paste binder with mix of powders including a silicate structurant. The aqueous AE3S paste (available from Stepan Company, Northfield, Ill., USA) is a blend of about 70% active Sodium Alkylethoxysulfate surfactant and about 25% water; the surfactant is an active and the water is a plasticizer. The powder raw materials comprise sodium carbonate (available from FMC Corporation, Philadelphia, Pa., USA) and a silicate structurant powder (developmental di-silicate material, Uniexcel Chemical Solutions, LLC, Brownsville, Tex., USA). The mass ratio of raw materials is about 30% sodium carbonate, 20% silicate powder and about 50% AE3S paste. The powders are pre-loaded into the batch mixer-agglomerator; then the paste is added to the powders at ambient temperature while the mixer agitator is running to disperse the paste binder into the powders. The time of injection is from about 1 to 4 minutes. The temperature of the resulting product is cooler compared to ambient conditions, suggesting an endothermic reaction. The product comprises about 35% active surfactant and about 12.5% residual moisture that is substantially bound by the structurant. A drying step to reduce the residual moisture is optional. However, no drying step is required to produce a resulting free-flowing structured particulate with a granule size distribution characterized by a mass-median (D50) of about 350 um and a span (D70/D30) of about 1.6.

### Example 2

### Structured Surfactant Particulate with Robust Environmental Stability

The physical flowability of a structured AES particulate prepared in accordance with Example 1 is characterized using applicants flowability test method. The flowability test is first done under ambient lab conditions (about 21 C, 30% RH) and then repeated for a sample exposed in an environmental test chamber (27 C, 74% RH), where the test sample is first allowed to equilibrate to the higher humidity condition for 24 hours before starting the test.

As a point of comparison, a non-structured particulate is prepared in a similar agglomeration process using the same AES surfactant paste and sodium carbonate, but without the silicate structurant. In this case, the active loading capacity is only about 20% active AES and requires a post-drying step to render the product flowable.

Under ambient conditions, flow functions of the 35% active structured AES particulate and 20% active non-structured AES particulate are similar, both in the “easy flow” classification. Under high humidity conditions, the structured AES particulate remains substantially unchanged, still in “easy flow”. On the other hand, the non-structured particulate becomes stickier in humid conditions, and its flow function shifts to the “cohesive” classification.

### Example 3

### Process Comparison of Making a Cleaning Active Particulate Using a Pre-Blend of a Chelant Active and Plasticizer, with and without Structurant

A series of high-shear agglomeration experiments are done using sodium carbonate powder and a chelant solution binder. The chelant is a hygroscopic material, tetrasodium carboxylatomethyl-glutamate (Dissolvine® or GLDA), available as an aqueous solution from Akzo Nobel Functional Chemicals, Chicago, Ill., USA. The experimental design includes additions of various candidate structurant materials including a developmental di-silicate material (Uniexcel Chemical Solutions, LLC, Brownsville, Tex., USA) and a commercial silicate that is used as a carrier for nonionic surfactants (BriteSil®, available from PQ Corporation, Philadelphia, Pa., USA). All powders were pre-micronized to equalize the effect of particle size on loading capacity.

In each experiment, an excess of binder is added using a fixed-rate binder injector, and the power-draw of the mixer is recorded. The active loading capacity is determined from the amount of binder added when the power draw exceeds a threshold level. The results based on the power-draw threshold analysis show that significantly higher loading capacities are achieved with the developmental di-silicate material from Uniexcel. Furthermore, the batches made using the Uniexcel material remained free flowing particulates, even at binder loadings in substantial excess of the power-draw threshold where other batches became very sticky and non-flowable.

### Example 4

### Structured Chelant Particulate with Robust Environmental Stability

The physical flowability of GLDA chelant particulates prepared in accordance with Example 3 is characterized according to a rapid stability test whereby thin layers of particulates are placed in Petri dishes and exposed to a stressed environmental test at 27 C and 80% RH for 48 hours. The moisture uptake of the samples is measured, and the physical stability is assessed. Non-structured samples comprising GLDA underwent deliquescence, resulting is a gel or even liquid layer in the Petri dish. On the other hand, structured particulate samples remained in a flowable particulate form.

### Example 5

### Layered Structured Particulate

A layered particulate is prepared according to US 2007/0196502 wherein the layering powder of US 2007/0196502 comprises a structurant and the binder of US 2007/0196502 comprises a mixture of an active and a plasticizer. An advantage of using a structurant as a layering powder is to enable higher binder loadings without the need for a drying step in the process and increasing the

A layered particle comprising multiple surfactants is prepared by adding an active layer comprising a co-surfactant to a seed agglomerate comprising a primary surfactant. In one aspect, the seed agglomerate comprises Sodium Linear Alkyl Benzyl Sulfonate (LAS) with an active level of from about 20% to 50% of the seed, and the layer comprises a surfactant paste binder, said paste comprising a Sodium Alkylethoxysulfate (AES) active and water plasticizer. Additional layers comprising chelant and/or soluble polymer may be included.

As described in US 2007/0196502, the tailings from pre-classification of seeds may be blended with other layering powder components, micronized, and then used in the layering process.

An example of a layered structured particulate is described in the following table. The layering powder blend may comprise a silicate structurant, where the amount of structurant is about 50% to 150% of the total plasticizer (i.e., moisture level) in the binder. With a suitable structurant amount, the drying requirement is eliminated and the layering addition rate may be increased, resulting in a reduction in the batch cycle time.

| Component | Mass % | Addition |
|---|---|---|
| Seed agglomerate comprising LAS surfactant | 40% | pre-load |
| Layering powder comprising a micronized blend | 48% | Layering |
| of seed tailings, sodium carbonate and silicate | | addition |
| structurant. | | |
| Binder comprising active and plasticizer; active | 12% | Layering |
| comprising AES surfactant, chelant and polymer; | | addition |
| plasticizer comprising water | | |

### Example 6

### An Active Bleach Particulate Comprising a Protective Structurant Layer

A layered particulate is prepared according to US 2007/0196502 wherein the seed comprises sodium percarbonte, the layering powder comprises a structurant and optional buffer materials and the binder comprises a plasticizer and optionally, an active. The buffer materials of this example are selected from sodium carbonate, sodium bicarbonate, sodium sulfate. The optional actives of this example are selected from chelant and soluble polymer materials, polymers including sodium polyacrylate and acrylic-maleic co-polymers. Preferable structurants include silicate and polyvinyl alcohol resin (PVA). When PVA is selected, a cross-linking agent such as boric acid may be included in the layering powder or the binder.

The advantages of the current example include the capability to make a thicker protective layer with a minimal drying load as well as additional stability benefits conferred by the structurant in the layer.

A suitable supply of granular sodium percarbonate may be obtained from a variety of suppliers including Solvay Chemicals Inc., Houston, Tex., USA; Evonik Industries AG, Essen, Germany; OCI Chemical Corporation, Marietta, Ga., USA. Either coated or uncoated sodium carbonate may used.

| Component | Mass % | Addition |
|---|---|---|
| Seed comprising sodium percarbonate. | 50 to 90% | pre-load |
| Layering powder comprising a micronized blend | 8 to 40% | Layering |
| of buffer materials and structurant. | | addition |
| Binder comprising plasticizer and optional | 2 to 20% | Layering |
| actives, optional actives comprising chelant and/ | | addition |
| or polymer. | | |

Due to the intrinsic chemical instability of sodium percarbonate, it is advantageous to use a drying step to minimize residual water in the layered particulate. When using uncoated percarbonate seeds, it is advantageous to use convective air drying during the layering process, as per US 2007/0196502.

### Example 7

### Process for Making a Structured Detergent Particulate Using an Emulsion of Silicone in a Pre-Blend of a Surfactant Active and Plasticizer

Silicone may be formulated in a cleaning composition to confer auxiliary product benefits. Depending on the product benefit desired, various silicones may be used, available from Dow Corning, Midland, Mich., USA; Wacker Chemie AG, Munich, Germany. Liquid silicone is first emulsified into a surfactant paste, for example the AE3S paste of example 1, using a suitable mixer, for example a rotor-stator mixer (e.g., Ultra Turrax™ available from IKA Works, Inc. Wilmington, N.C., USA), preferably in a ratio of about 10 to 40 mass % of silicone. The resulting silicone in surfactant paste emulsion is then used as a binder in an agglomeration or layering process, exemplified in examples 1 and 5, respectively. Since exposure to higher temperatures may have a destructive on the emulsion, the level of structurant is preferably chosen to make a structure particle without the need of a drying step, thus eliminating the need to heat the material and preserving the emulsion structure.

### Example 8

### Instant-Emulsion Particulate Comprising Silicone

Delivery of an active emulsion via a dry-laundry product is exemplified herein. The particle of example 7 is dispersed into an washing vessel and agitated. Upon dissolution, the wash water instantly becomes cloudy and turbid. The dispersed material comprises silicone and is characterized by median droplet sizes in the range of from about 1 to 100 micrometers.

### Example 9

### Enzyme Structured in PVA Matrix Particle

A structured particle comprising enzymes is prepared using a structurant comprising polyvinyl alcohol resin (PVA) and an enzyme broth comprising a plasticizer and active enzyme such as protease or lipase. PVA resin is available from Sigma-Aldrich, St. Louis, Mo., USA; Kuraray America, Inc., Houston, Tex., USA. Enzyme broths with active enzyme concentrations from about 2% to 20% are available from Novozymes A/S, Bagsvaerd, Denmark; Danisco US Inc., Genencor Division, Rochester, N.Y., USA. Optional buffer materials may include sodium sulfate. The plasticizer may comprise water, glycol and optionally other diols that may be present in the enzyme broth. Optionally, a boric acid cross-linker for the PVA may be added as a separate binder solution or pre-mixed with the enzyme broth.

Particle making may be done as a batch process using a suitable medium to high-shear mixer-agglomerator. Preferably, the process temperature is controlled in the mixer such that the structurant glass transition is reduced below the process temperature, but not too hot to significantly damage the active enzymes. The initial glass transition of the dry PVA resin is about 8° C. With a moisture content of about 6 to 10 mass %, the glass transition drops to about 10 to 20 C. At higher moisture contents, the glass transition drops further. Preferentially, the temperature of the product within the process should be between about 25 C and 50 C. This can be controlled by use of a jacketed mixer or a cross flow convective airflow with warm air.

| Component | | Mass % | Addition |
|---|---|---|---|
| Powder | Structurant (PVA resin) | 25% to 95% | pre-load |
| Powder | Optional buffer (sodium sulfate) | 0 to 70% | pre-load |
| Binder | Enzyme broth, optionally w/ | 5% to 50% | Gradual |
| | boric acid | | |
| Binder | Optional aqueous boric acid | 0% to 10% | post- |
| | solution (~4%) | | enzyme |

If necessary, the resulting agglomerate may be further treated to reduce residual moisture, e.g., by a gentle drying process where inlet temperatures are controlled to avoid excessive heating of the product and potential degradation of the active enzymes.

If the material is to be used in a granular detergent formulation, the resulting agglomerates may be classified to a desired particle size specification, fines may be recycled, and oversize may be milled reduce their size for re-classification.

If the material is to be used in a liquid detergent application, for example by dispersing the particles into the liquid as a suspension, then it may be preferable to micronize the material to a finely-distributed powder, for example using an air-classifier mill, with a median particle size less than about 20 microns.

While not being bound by theory, it is believed that milling does not significantly compromise the stability of the enzymes because the primary mode of stabilization is by immobilization of the protein molecule in the amorphous PVA network; a coherent barrier layer is not required.

The resultant product has predominantly amorphous structure of the PVA structurant with an active enzyme concentration of about 0.5% to 5%., and is suitable for addition into a finished product.

### Example 10

### Heavy Duty Liquid Detergent Product Comprising Structured Enzyme Particles

The micronized enzyme particles of Example 9 are mixed into a substantially anhydrous or low-water heavy-duty liquid detergent such that the particles are suspended in the liquid. Multiple types of enzyme particles may be used as a means to formulate with enzymes that are incompatible with the liquid detergent or incompatible with other enzymes. Depending on the activity of the enzyme particles and the formulation, the amount of particles may be from about 0.2% to about 10% of the detergent.

While not being bound by theory, it is believed that the shelf-life stability of the product can be optimized by matching the moisture activity of the enzyme particles with the moisture activity of the liquid detergent matrix. The enzymes release in use as the structurant dissolves upon dilution in wash water.

### Example 11

### Process for Making a Structured Detergent Particulate Using a Composite Spray-Dried Structurant

A structured particulate is prepared using a structurant prepared by a composite spray-drying process. The spray drying process comprises a conventional detergent spray dryer that is modified to have two independent slurry or solution compositions: 1) the a conventional detergent slurry; 2) a structurant composition. The structurant composition may comprise any structurant or precursor of any structurant described in the current application. In one aspect, the structurant composition comprises a silicate solution, for example as described in WO2007/082291. In one aspect, the structurant composition comprises a slurry comprising silicate solution and dispersed sodium sulfate particles, said sulfate particles preferably micronized to a particle size median less than about 20 um. The spray drying process is conducted in a manner to produce a composite granule comprising both detergent and structurant compositions, preferably with the structurant material located substantially on the surface of said composite granules.

The structurant made using said composite spray drying process is then used as a substrate in an agglomeration or layering process. An agglomeration process may be conducted as per Example 1. Optionally, the composite spray dried granules may be milled or micronized to create a fine powder substrate, for example as described in US2006/0035803. Optionally, the structurant made using said composite spray drying process may be used as a seed in a layering process as described in US2007/0196502, where the structurant is located at the surface of the spray-dried composite seed.

### Example 12

### Process for Making a Structured Detergent Particulate Using a Pre-Blend of a Surfactant Active and Plasticizer

The process of Example 1 is used with a concentrated aqueous surfactant paste binder. The surfactant paste may be prepared by direct neutralization with very low levels of water, or a conventional aqueous paste may concentrated by a moisture evaporation process. The resultant concentrated surfactant paste has an active surfactant level of about 90% and a water level of about 5%. The materials are combined in a mixer agglomeration process as described in example 1, with a mass ratio of raw materials of about 30% sodium carbonate, 20% silicate structurant powder and about 50% concentrated surfactant paste. The product comprises about 45% active surfactant and about 2.5% residual moisture that is substantially bound by the structurant. No subsequent drying step is required.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process of preparing a particle, the particle comprising:
(i) cleaning active;
(ii) structurant having a glass transition temperature; and
(iii) optionally, plasticizer;
wherein the process comprises the step of:
(a) contacting the plasticizer, the structurant, and the cleaning active to form a mixture, and forming a particle from the mixture;
(b) optionally, removing at least part of the plasticizer from the mixture and/or particle of step (a);
wherein the structurant undergoes a glass transformation during step (a) to create an amorphous structure which stabilizes the cleaning active.

2. A process according to claim 1, wherein the plasticizer and cleaning active are pre-mixed prior to contact with the structurant.

3. A process according to claim 1, wherein the unplasticized structurant has a glass transition temperature above the temperature of step (a), and wherein during step (a), the structurant is plasticized, and wherein the temperature of step (a) is controlled such that the glass transition temperature of the plasticized structurant is below the temperature of step (a).

4. A process according to claim 1, wherein the structurant is water-soluble.

5. A process according to claim 1, wherein the structurant comprises silicate salt.

6. A process according to claim 1, wherein the structurant comprises polymer.

7. A process according to claim 1, wherein the plasticizer comprises water.

8. A process according to claim 1, wherein the cleaning active is selected from detersive surfactant, chelant, water-soluble polymer, enzyme, bleaching active, perfume, hueing agent, silicone and any combination thereof.

9. A process according to claim 1, wherein the plasticizer comprises water, and wherein step (b) is carried out, and wherein step (b) is an evaporative drying step wherein at least part of the plasticizer is removed from the mixture and/or particle of step (a).

10. A process according to claim 1, wherein the particle comprises at least 30 wt % cleaning active selected from detersive surfactant, chelant, water-soluble polymer, and any combination thereof.

11. A process according to claim 2, wherein the weight ratio of cleaning active to plasticizer present in the pre-mix is in the range of from 3:1 to 99:1.

12. A process according to claim 1, wherein the cleaning active is hygroscopic.

13. A particle made according to the process of claim 1.

14. A particle made according to the process of claim 10.

15. A particle according to claim 13, wherein the particle when initially equilibrated to ambient conditions of from 30% relative humidity and temperature of 22° C., and then exposed in an open container for 24 hours to conditions of (i) environmental relative humidity of 74%, and (ii) a temperature of 27° C., retains a flowability of at least 4.

16. A cleaning composition comprising the particle of claim 13.

17. A cleaning composition according to claim 16, wherein the composition has a reserve alkalinity of 12 or less.
